(19) United States
(12) Patent Application Publication
(10) Pub. No.: US 2025/0152471 A1
(43) Pub. Date: May 15, 2025

(54) ELASTIC STRUCTURE FOR DISTRIBUTION OF ACUPRESSURE AND BODY PRESSURE

(71) Applicant: MEDSAPIENS CO., LTD., Hanam-si, Gyeonggi-do (KR)

(72) Inventor: Hee Soo KIM, Hanam-si, Gyeonggi-do (KR)

(73) Assignee: MEDSAPIENS CO., LTD., Hanam-si, Gyeonggi-do (KR)

(21) Appl. No.: 18/835,010

(22) PCT Filed: Feb. 2, 2023
(86) PCT No.: PCT/KR2023/001494

§ 371 Date: Jul. 31, 2024

(30) Foreign Application Priority Data
Feb. 8, 2022 (KR) 10-2022-0016376

(51) Int. Cl. A61H 39/04

(52) U.S. Cl. CPC A61H 39/04; A61H 2201/1695

(57) ABSTRACT

An elastic structure includes an elastic protrusion formed of a plurality of ribs having at least a portion of their vertical cross-section triangularly shaped; and a solid column housing said elastic protrusion, wherein at least one of the vertices of said elastic protrusion is connected to an inner circumferential edge of said solid column, and wherein said plurality of ribs are connected to said solid column to form a truss structure.

### TECHNICAL FIELD

The present invention relates to an elastic structure for pressure relief and weight distribution that can be used in cushions and toppers.

### BACKGROUND ART

Prior art includes Korean Patent Registration No. 1443193 and Korean Patent Registration No. 948485. However, the cushions according to prior art have the problem of insufficient shape recovery and difficulty in heat dissipation from the body.

### DETAILED DESCRIPTION OF THE INVENTION

### Technical Problems

The technical problems to be solved by the present invention are as follows.

First, to provide an elastic structure that can distribute body pressure while preventing excessive compression, thus maintaining proper posture.

Second, to provide an elastic structure with high elasticity and excellent durability.

Third, to provide an elastic structure that facilitates free air circulation and easy heat dissipation.

Fourth, to provide an elastic structure that stimulates muscles to improve blood circulation and relaxes muscles to aid in fatigue recovery.

The technical problems of the present invention are not limited to those mentioned above, and any additional problems not explicitly mentioned can be clearly understood by those skilled in the art from the detailed description below.

### Means for Solving the Problem

To achieve the above objectives, an elastic structure according to an embodiment of the present invention comprises: an elastic protrusion formed by a plurality of ribs, at least some of which have a triangular vertical cross-section; and a three-dimensional column that accommodates the elastic protrusion, wherein at least one vertex of the elastic protrusion is connected to an edge of the inner surface of the three-dimensional column, and the plurality of ribs are connected to the three-dimensional column to form a truss structure.

Additionally, an elastic structure according to an embodiment of the present invention comprises: an elastic protrusion in the shape of a hexagonal pyramid with a contraction-allowance groove formed between the edges; and a three-dimensional column in the shape of a hexagonal pillar that accommodates the elastic protrusion and whose inner surface is connected to the side vertices of the elastic protrusion.

Specific details of other embodiments are included in the detailed description and drawings.

### Effects of the Invention

Firstly, it is possible to provide an elastic structure that disperses body pressure while preventing excessive contraction, thereby maintaining proper posture.

Secondly, it is possible to provide an elastic structure with high elasticity and excellent durability.

Thirdly, it is possible to provide an elastic structure that allows for free air circulation and facilitates easy heat dissipation.

Fourthly, it is possible to provide an elastic structure that stimulates muscles to improve blood circulation and relaxes muscles to aid in fatigue recovery.

The effects of the present invention are not limited to those mentioned above, and additional effects not mentioned can be clearly understood by those skilled in the art from the description of the claims.

### BRIEF DESCRIPTION OF THE DRAWINGS

FIG. 1 is an enlarged view of the surface of an elastic structure according to an embodiment of the present invention.

FIG. 2A is an enlarged view of the upper surface of an elastic structure according to an embodiment of the present invention, and FIG. 2B is an enlarged view of the lower surface of the same elastic structure.

FIG. 3 is a cross-sectional view taken along line 3-3 of FIG. 1.

FIG. 4 is an enlarged view of point K in FIG. 3.

FIG. 5A illustrates a rib according to an embodiment of the present invention, FIG. 5B shows a vertical cross-sectional view of two ribs combined as shown in FIG. 5A, FIG. 5C depicts a rib according to another embodiment of the present invention, and FIG. 5D shows a vertical cross-sectional view of two ribs combined as illustrated in FIG. 5C.

FIG. 6 is a cross-sectional view of an elastic protrusion according to another embodiment of the present invention.

FIG. 7 shows an elastic structure according to an embodiment of the present invention cut at an angle.

FIG. 8A illustrates the forces acting on an elastic structure according to an embodiment of the present invention in a top view.

FIG. 8B is a cross-sectional view showing the forces acting on the elastic structure of FIG. 8A.

FIG. 8C depicts the forces acting on an elastic structure according to another embodiment of the present invention in a cross-sectional view.

FIG. 9A is a top view illustrating the effects of the elastic structure according to an embodiment of the present invention.

FIG. 9B is a cross-sectional view taken along line 9-9 of FIG. 9A.

### DETAILED DESCRIPTION OF THE EMBODIMENTS

The advantages and features of the present invention, as well as the methods for achieving them, will become apparent from the detailed description of the embodiments provided below, with reference to the accompanying drawings.

However, the present invention is not limited to the embodiments disclosed below and may be implemented in various other forms. The embodiments provided here are intended to ensure that the disclosure of the invention is complete and to fully inform those skilled in the art of the scope of the invention. The invention is defined solely by the claims. Throughout the specification, the same reference numerals refer to the same components.

Hereinafter, the present invention will be described with reference to the drawings.

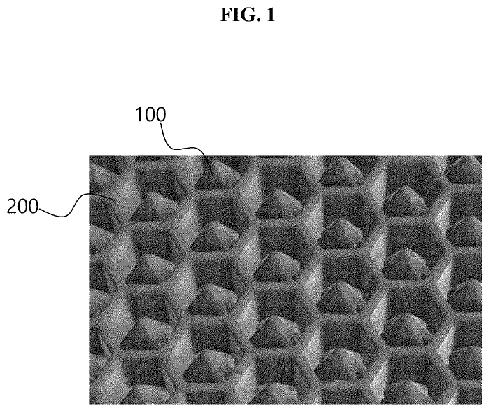

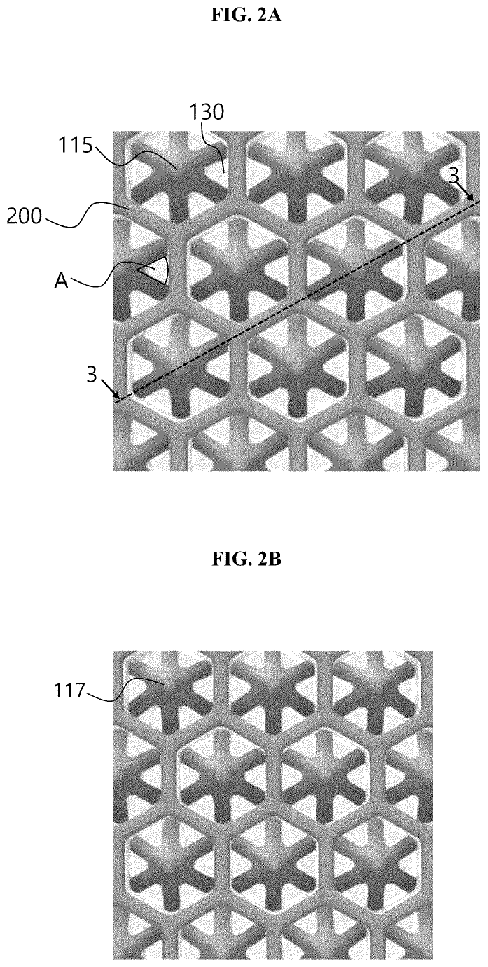

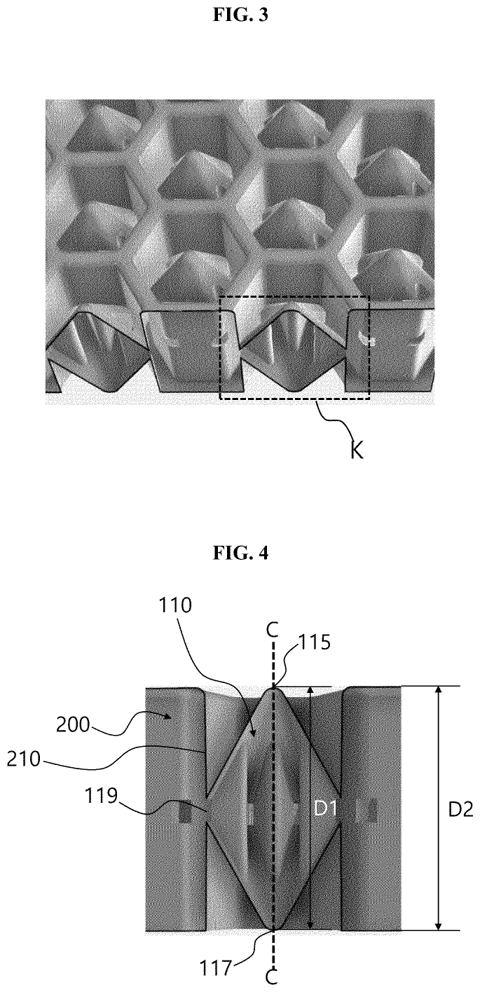

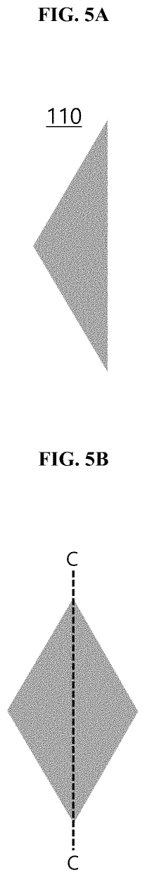

FIG. 1 is an enlarged view of a surface of an elastic structure of an embodiment of the present invention. FIG. 2a is an enlarged view of a top surface of an elastic structure of an embodiment of the present invention, and FIG. 2b is an enlarged view of a bottom surface of an elastic structure of an embodiment of the present invention. FIG. 3 is a 3-3 cross-sectional view of FIG. 1. FIG. 4 is a magnified view of point K of FIG. 3.

Referring to FIGS. 1 to 4, an elastic structure according to an embodiment of the present invention includes an elastic protrusion 100 formed of a plurality of ribs 110, 120 having a triangular vertical cross-section; and a cylindrical column 200 housing the elastic protrusion 100, wherein lateral vertices 119 of the elastic protrusion 100 connect with inner circumferential edges 210 of the cylindrical column 200.

The resilient protrusion 100 is shaped as a plurality of ribs 110, 120 joined together. The plurality of ribs 110, 120 may be integrally formed. The three-dimensional column 200 forms an interior hollow space. The solid column 200 houses the resilient protrusions 100. The elastic protrusion 100 and the solid column 200 may be integrally formed. The elastic protrusions 100 and the three-dimensional column 200 are formed of an elastic material, such as a silicone material, memory foam, elastomer, urethane material, silicone material, etc. The top and bottom surfaces of the three-dimensional column 200 are open to allow air to circulate.

In the following description, edges 210 of the three-dimensional column 200 refer to edges formed on the sides and edges formed in the vertical direction. The three-dimensional column 200 may be a triangular column, a quadrilateral column, a pentagonal column, or a hexagonal column. The inner circumferential surface of the solid column 200 has corners 210 formed thereon, and the elastic protrusion 100 is shaped to engage the corners 210 of the inner circumferential surface of the solid column 200. Depending on the number of corners 210 of the solid column 200, the number of ribs 110, 120 varies. The number of edges 210 and the number of ribs 110, 120 of the solid column 200 may be the same.

A plurality of ribs 110, 120 share an axis connecting the upper vertex 115 and the lower vertex 117. The ribs 110, 120 form the upper vertex 115 and the lower vertex 117. The plurality of ribs 110, 120 are joined and share the upper vertex 115. The plurality of ribs 110, 120 are joined and share a lower vertex 117. The plurality of ribs 110, 120 are joined to form a single elastic protrusion 100. The single resilient protrusion 100 is shaped to have a single upper vertex 115 and a single lower vertex 117. Forming a single vertex is advantageous for the manufacturing process. The single vertex increases the acupressure effect on soft tissues such as skin, fascia, and muscle. However, a plurality of upper vertices 115 and lower vertices 117 may be formed by spacing them apart from the axis as will be described later.

The plurality of ribs 110, 120 are disposed at the same angle about the axis. The plurality of ribs 110, 120 are disposed at a 60 degree angle to each other. The size of the angle depends on the number of ribs 110, 120. The angle refers to the angle between the ribs 110, 120. The angle refers to the included angle between adjacent ribs 110, 120 about the center axis. An included angle is the angle created between two straight lines when they meet.

Between the plurality of ribs 110, 120, a shrinkage allowance groove 100a is formed to allow deformation due to vertical loading of the ribs 110, 120. The upper vertex 115 and lower vertex 117 are in contact with the ground or body and are subject to elastic deformation. The upper vertex 115 and lower vertex 117 bend as they move toward each other, so they need space to allow for deformation. The shrinkage allowance groove 100a is a hole for air circulation. The top vertex 115 and bottom vertex 117 and the cubic column 200 are elastically deformed, so the space contracts and relaxes, which induces a change in air pressure. Air is circulated by the change in air pressure, and body heat is discharged to the outside.

The height of the upper vertex 115 of the ribs 110, 120 and the lower vertex 117 of the ribs 110, 120 is less than or equal to the height of the three-dimensional column 200. If the upper vertex 115 or the lower vertex 117 protrudes, additional friction forces and excessive pressure forces may be generated. Therefore, the height of the upper vertex 115 and lower vertex 117 should be selected for a proper balance of friction and pressure. The height of the upper vertex 115 and the lower vertex 117 is determined relative to the height of the three-dimensional column 200.

The elastic structure according to an embodiment of the present invention comprises an elastic protrusion 100 having a shrinkage-permitting groove 100a formed in the shape of a hexagonal cone and a hollow space between the edges 210; and a three-dimensional column 200 in the shape of a hexagonal column housing the elastic protrusion 100 and having an inner circumferential surface connected with the side vertices 119 of the elastic protrusion 100.

The resilient protrusion 100 is triangular in shape and comprises a plurality of ribs 110, 120 having an upper vertex 115 and a lower vertex 117 coaxially joined.

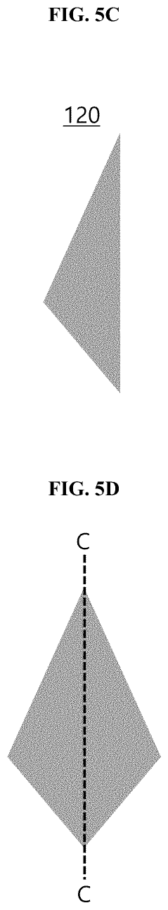

FIG. 5A is a representation of rib 110 according to an embodiment of the present invention, and FIG. 5B is a vertical cross-sectional view of two of the ribs 110 of FIG. 5A joined together.

Referring to Figures SA and SB, the shape of the vertical cross-section of the elastic protrusion 100 is that of a plurality of ribs 110 joined about an axis.

The vertical cross-sectional shape of the elastic protuberance 100 may be the same as the shape of two ribs 110 joined together. The vertical cross-section of the elastic protuberance 100 may be rhombus shaped. A rhombus is a type of parallelogram, which is a rectangle with all four sides of equal length. A rhombus has the property that its two diagonals vertically bisect each other.

The square shape formed by the joining of the ribs 110 may also be a square where the angle at the intersection of the two diagonals is a right angle. Together, the ribs 110 may have two pairs of stools each having the same length and two pairs of diagonals each having the same size.

FIG. 5C is a representation of ribs 120 according to another embodiment of the present invention, and FIG. 5D is a vertical cross-sectional view of two of the ribs 120 of FIG. 5C combined.

Referring to FIGS. 5C to 5D, the vertical cross-sectional shape of the elastic protrusion 100 by another embodiment of the present invention may be such that the plurality of ribs 120 are joined about an axis such that two neighboring sides have the same length, and the lengths of the stools are different.

In this case, the shape of the elastic protrusion 100 is asymmetrical up and down. If the angle of engagement between the two neighboring sides is small, the vertex is more pointed, which results in a stronger compressive force. Conversely, if the angle of engagement is larger, the pressure is weaker. The user can select the strength of the acupressure force by flipping the elastic structure according to his/her preference.

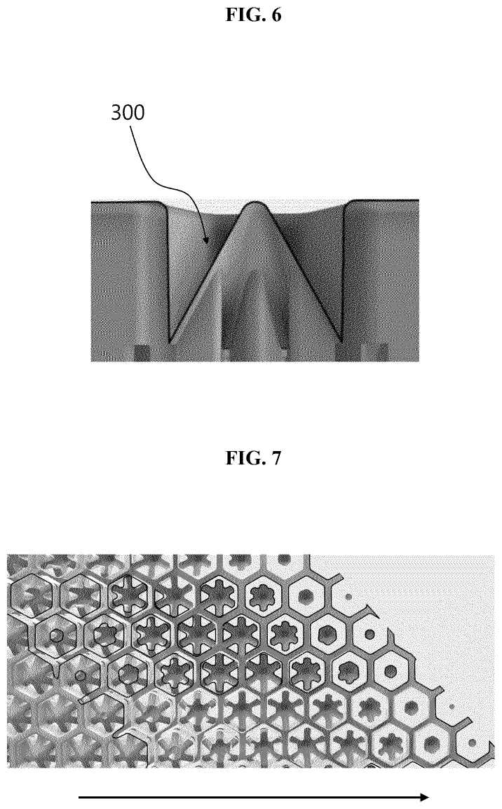

FIG. 6 is a cross-sectional view of the elastic protrusion 300 according to another embodiment of the present invention.

Referring to FIG. 6, the elastic protrusion 300 of the other embodiment may be a bisection of the elastic protrusion 100 of FIG. 4, up and down. Thus, the detailed configuration of the elastic protrusion 100 and the other elastic protrusion 300 is the same.

With this form of elastic protrusion 300, the truss structure is still maintained. On the other hand, this type of elastic protrusion 300 has a relatively large contact area with the bottom surface, so that the deformation of the lower portion is suppressed. Furthermore, the suppression of the deformation of the lower portion has the effect of suppressing the deformation of the upper portion. This type of elastic protrusion 300 can increase the stimulating force of the human body contact area of the upper part.

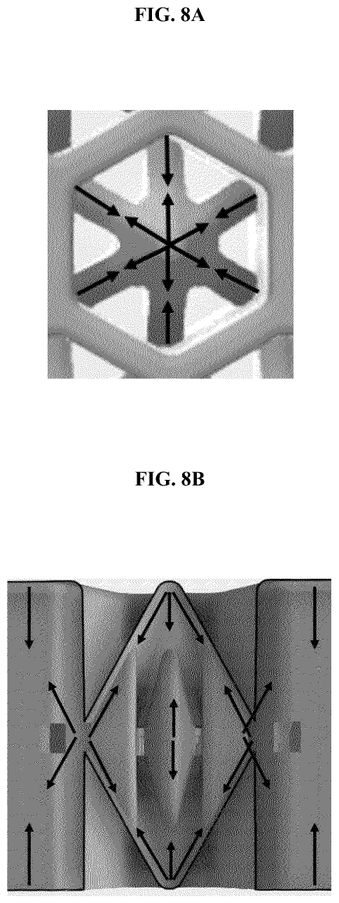

FIG. 7 is an illustration of an inclined cut of an elastic structure according to an embodiment of the present invention.

Referring to FIG. 7 and again to FIG. 2A, the horizontal cross-section of the shrinkage allowance groove 100A is triangular. The ribs mate with the edges 210 of the cuboidal column 200, so that two sides of the shrinkage tolerance groove 100a are ribs 110, 120 and one side is the cuboidal column 200.

Referring to FIG. 7, the shape of the horizontal cross-section of the resilient protrusions 100 and the solid column 200 varies with height. The direction of the arrows is in the direction of gradually decreasing height. At higher heights, the upper vertex 115 can be seen. As the height gradually decreases, the side vertices 119 are exposed. As the height continues to decrease and approaches the bottom, the lower vertices 117 can be seen. The shape of the shrinkage allowance groove 100a gradually changes with height. The shape of the shrinkage allowance groove 100a is approximately a triangular horn.

In the embodiment of the present invention, the top and bottom of the elastic protrusion 100 are shown as symmetrical, but the shape of the elastic protrusion 100 may be asymmetrical at the top and bottom, as shown in FIG. 5D.

The cubic column 200 is in the form of a hexagonal column with a square cross-section in the horizontal direction. The lateral vertices 119 of the elastic protrusions 100 engage the middle portions of the inner circumferential edges 210 of the hexagonal column. However, the height of engagement may vary depending on the shape of the resilient protrusion 100.

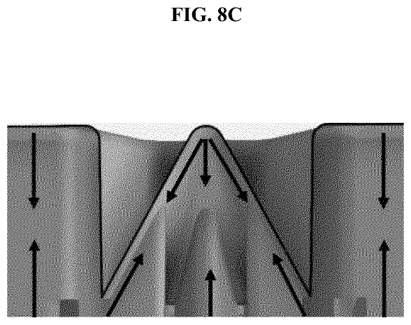

FIG. 8A is a top view representation of the force applied to an elastic structure by an embodiment of the present invention. FIG. 8b is a cross-sectional view of a force on an elastic structure by an embodiment of the present invention. FIG. 8C is a cross-sectional view of a force on an elastic structure by another embodiment of the present invention.

Referring to FIGS. 8A and 8B and FIG. 8C, the effect of the elastic structure of the present invention is described as follows.

When a user applies a load to the elastic structure, such as lying or sitting on it, the body weight acts on the top vertex 115 and the top surface of the three-dimensional column 200. The weight applied to the upper vertex 115 is distributed to the respective ribs 110, 120 and impacts the inner edges 210 of the solid column 200.

The lower vertex 117 and the lower face of the solid column 200 are subjected to an upward force. The solid column 200 and ribs 110, 120 are elastically deformed and balanced by the action and counteraction.

The structure of the elastic structure according to the present invention consists of a combination of triangular structures. The three-dimensional column 200 and the elastic protrusions 100 form a truss structure. Therefore, the structure is geometrically more stable than conventional vertical and horizontal structures. In other words, the structure of the present invention is elastically deformed due to the elastic material, but the deformation of the shape is minimized.

Minimized form deformation increases the force of the reaction to relax the user's muscles. The truss structure prevents excessive deformation (bending) to either side, allowing the muscles to relax uniformly.

It also increases durability by minimizing deflection of the elastic structure. The truss structure maintains uniform ventilation by keeping the size of the shrinkage allowance holes constant.

According to FIG. 8C, the elastic protrusions 300 of another embodiment of the present invention have an increased contact area with the bottom surface, so that the deformation of the bottom surface is suppressed, thus exerting a stronger stimulating force (acupressure force) on the user. This shape increases the acupressure effect, such as muscle relaxation and improved blood circulation.

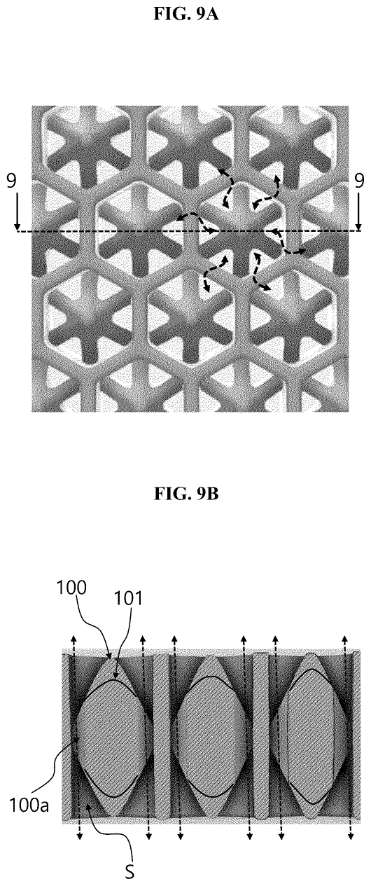

FIG. 9A is a plan view illustrating the effect of the elastic structure of an embodiment of the present invention. FIG. 9B is a 9-9 cross-sectional view of FIG. 9A.

Referring to FIGS. 9A and 9B, the elastic structure of an embodiment of the present invention allows air to circulate through shrinkage allowance holes 100A. The shrinkage allowance hole 100a is a space through which air circulates while allowing the elastic protrusions 100, 300 to deform. Meanwhile, a chamber S is formed between the elastic protrusions 100, 300 and the three-dimensional column 200.

When a load is applied to the elastic protrusions 100, 300 and the three-dimensional column 200, they deform, which deforms the shape of the chamber S. The shape deformation of the chamber S creates an air pressure difference, which induces air circulation.

While preferred embodiments of the invention have been shown and described above, the invention is not limited to the specific embodiments described above, and various modifications may be made by those having ordinary skill in the art to which the invention belongs without departing from the spirit of the invention as claimed in the patent claims, and such modifications should not be understood in isolation from the technical ideas or views of the invention.

1. An elastic structure comprising:
an elastic protrusion formed by a plurality of ribs with at least some of the vertical cross-sections being triangular in shape; and
a three-dimensional column that houses the elastic protrusion, wherein at least one vertex of the elastic protrusion is connected to the edge of the inner surface of the three-dimensional column, and
the plurality of ribs are connected to the three-dimensional column to form a truss structure.

2. The elastic structure of claim 1, wherein the plurality of ribs are arranged to form the same angle around an axis.

3. The elastic structure of claim 1, wherein the elastic protrusion is composed of a plurality of truss structures that are stacked with the same angle, distributing compression forces applied at the upper end of the elastic protrusion to the three-dimensional column.

4. The elastic structure of claim 2, wherein the vertical cross-sectional shape of the elastic protrusion is a rhombus, formed by the plurality of ribs being combined around the axis.

5. The elastic structure of claim 2, wherein the vertical cross-sectional shape of the elastic protrusion is such that the plurality of ribs are combined around the axis with two adjacent sides of equal length and a different length for the longer side.

6. The elastic structure of claim 1, wherein the height connecting the upper vertex and lower vertex of the ribs is less than or equal to the height of the three-dimensional column.

7. The elastic structure of claim 1, wherein a contraction-allowing groove is formed between the plurality of ribs, allowing deformation due to vertical loads on the ribs, and the horizontal cross-section of the contraction-allowing groove is triangular.

8. The elastic structure of claim 1, wherein the height connecting the upper vertex and lower vertex of the ribs is equal to the height of the three-dimensional column, the three-dimensional column is a hexagonal column with a horizontal cross-section in the shape of a regular hexagon, and the elastic protrusion is an elastic structure in which a plurality of rhomboid columns overlap, sharing the upper and lower ends.

9. The elastic structure of claim 8, wherein the elastic protrusion and the three-dimensional column are combined such that the structure allows for axial forces like compression and tension but does not allow for the generation of moments.

10. The elastic structure of claim 1, wherein the plurality of ribs are arranged at 60-degree angles relative to each other and share an axis connecting the upper vertex and lower vertex.

11. An elastic structure comprising:
an elastic protrusion in the shape of a hexagonal pyramid with contraction-allowing grooves formed between edges; and
a three-dimensional column in the form of a multi-sided column that accommodates the elastic protrusion, with its inner surface connected to the side vertices of the elastic protrusion.

12. The elastic structure of claim 11, wherein the elastic protrusion comprises a plurality of ribs combined with the same axis connecting the upper and lower vertices, forming an elastic structure with overlapping truss structures.
